(19) United States
(12) Patent Application Publication
(10) Pub. No.: US 2019/0058732 A1
(43) Pub. Date: Feb. 21, 2019

(54) SYSTEM AND METHOD FOR DETECTION AND ISOLATION OF NETWORK ACTIVITY

(71) Applicant: Qatar Foundation for Education, Science and and Community Developmen, Doha (QA)

(72) Inventors: Mtibaa Abderrahmen, Doha (QA); Khaled A. Harras, Doha (QA); Hussein Alnuweiri, Doha (QA)

(21) Appl. No.: 15/780,572

(22) PCT Filed: Nov. 30, 2016
(86) PCT No.: PCT/GB2016/053757

§ 371 Date: May 31, 2018

(30) Foreign Application Priority Data
Dec. 1, 2015 (GB) 1521137.8

(51) Int. Cl. H04L 29/06; H04W 4/80

(52) U.S. Cl. CPC H04L 63/1491; H04L 63/1425; H04L 63/1458; H04L 2463/146; H04L 2463/144; H04W 4/80

(57) ABSTRACT

A security method in a network environment comprising a corporate network populated with one or more devices connectable to the corporate network over a first communication interface and connectable to other devices over a device-to-device communication interface distinct from the first communication interface, each device comprising a node in the network, one or more of the devices comprising a mobile device and one or more of the devices comprising an intentionally vulnerable node in the network, the method comprising: logging exchanged messages across the interfaces at the intentionally vulnerable node; monitoring the interfaces; identifying a candidate malicious message; tracking back from messages, including from a candidate malicious message; determining the paths used by the messages; determining the source and/or destination of a path to localise the candidate malicious message source.

### BACKGROUND

A HoneyBot is a defense technique for malicious device to device (d2d) communication. It consists of detecting, tracking, and isolating any malicious activity in a d2d disconnected opportunistic network such as MobiBots.

A MobiBot is a mobile malicious network, typically called a botnet, consisting exclusively of a set of infected mobile devices/bots capable of initiating sophisticated cyberattacks while coordinating together via d2d short range wireless communication such as Bluetooth. A MobiBot is infected and managed by one or many botmasters that aim to control many mobile devices to prepare them for potential insider attacks.

Recent studies show that more than 80% of security attacks are caused by corporate insiders with a rate of more than 5 insider attacks per year for more than one-third of the companies in the world.

These insider attacks are not stoppable using traditional security countermeasures such as firewalls, intrusion detection systems, or antivirus software. Therefore, companies are requested to detect, isolate, and protect their network from such attacks.

The continuous rising demand for computational resources by mobile applications has enabled various solutions for computational offloading to more powerful surrogate machines, known as cyber foraging [8]. Recent solutions include CloneCloud [4] and MAUI [5] that decide, for any given task, whether to execute this task locally or to offload it to a remote cloud. The impact of large RTT's on power consumption when offloading computation is further examined and utilized as an incentive for bringing resource-rich computational infrastructure, known as cloudlets [23] closer to mobile devices.

This trend has been pushed to the extreme with more recent mobile edge computing platforms being proposed such as, Mobile Device Clouds [13], [18] and FemtoClouds [9]. Such platforms leverage device-to-device communication to enable computational offloading among collaborative mobile devices for a multitude of purposes. Examples of such purposes include reducing the overall energy [13], ensuring resource balancing across devices [14], reducing execution time [24], [9], or simply executing applications whose computing requirements transcend what can be accomplished on a single device [13], [14]. However, these novel mobile computing platforms, which enable not only file sharing but also remote code offloading, render mobile devices an attractive target for malicious users.

We anticipate challenging future security attacks resulting from the adoption of collaborative mobile edge cloud computing platforms, such as MDCs and FemtoClouds. In typical botnet attacks, “vertical communication” between a botmaster and infected bots, enables attacks that originate from outside the network [7], [3], [7], [27], [26]. While intrusion detection systems typically analyze network traffic to detect anomalies, honeypots are used to attract and detect attackers [11], [25], and firewalls are placed at the network periphery to filter undesired traffic. However, these traditional security measures are not as effective in protecting networks from insider attacks such as MobiBots, a mobile-to-mobile distributed botnet [17].

This shortcoming is due to the mobility of bots and the distributed coordination that takes place in MobiBot attacks. In contrast to classical network attacks, these attacks are difficult to detect because MobiBots adopt “horizontal communication” that leverages frequent contacts amongst entities capable of exchanging data/code. In addition, this architecture does not provide any pre-established command and control channels (C&C) between a botmaster and its bots. Overall, such mobile device infections will circumvent classical security measures, ultimately enabling more sophisticated and dangerous attacks from within the network.

Researchers have been studying botnet detection and infection in wireless [7] and cellular networks [3]. MoBots [7] highlight the challenges and the limitations of botnet detection in mobile environments.

Proposed techniques that detect and track botnet activities, including honeypots [25] and honeynets [11], use network behavior analysis that may not be suitable or tuned for mobile-to-mobile distributed communication [29]. While these techniques have shown satisfying results in malicious scenarios based on infrastructure networks, they fail in detecting insider attacks that leverage d2d multi-hop communication which avoid intrusion detection software and firewalls [17].

Security research in d2d communication has evolved with ad-hoc networking research [6], [28]. Many security protocols have been proposed, however they mainly use a central trusted entity [28] or assume full connectivity (i.e., any node can be contacted “instantaneously” using wireless or wired links) [6]. This assumption cannot be defended in challenged opportunistic networks where links are intermittent by default, and end-to-end paths between any two nodes may not exist as in MobiBots [17], [15].

Intermittent network security solutions, however, have been limited to cryptography techniques, or trust filters that ensure trustworthy d2d communication between two nodes [10]. In this paper, we investigate novel security threats emerging from d2d computation offloading across mobile devices. To the best of our knowledge, while security challenges for such networks have been discussed in the past [17], defense solutions have never been proposed.

### DETAILED DESCRIPTION OF INVENTION

Clause 1. A security method in a network environment comprising a corporate network populated with one or more devices connectable to the corporate network over a first communication interface and connectable to other devices over a device-to-device communication interface distinct from the first communication interface, each device comprising a node in the network, one or more of the devices comprising a mobile device and one or more of the devices comprising an intentionally vulnerable node in the network, the method comprising:
logging exchanged messages across the interfaces at the intentionally vulnerable node;
monitoring the interfaces;
identifying a candidate malicious message;
tracking back from messages, including from a candidate malicious message;
determining the paths used by the messages;
determining the source and/or destination of a path to localise the candidate malicious message source.
   2. The method of clause 1, wherein the intentionally vulnerable node logs all exchanged messages across all interfaces.
   3. The method of any preceding clause, wherein the device-to-device communication interface is a short range wireless communication method, e.g. Bluetooth™.
   4. The method of any preceding clause, wherein monitoring the interfaces comprises monitoring the interfaces for intrusions.
   5. The method of any preceding clause, wherein the method utilises tracking heuristics and algorithms implemented at the one or more intentionally vulnerable nodes.
   6. The method of any preceding clause, wherein a plurality of intentionally vulnerable nodes are provided.
   7. The method of any preceding clause, wherein the plurality of intentionally vulnerable nodes are physically distributed around the network and tracking comprises physically locating a candidate malicious node in the network.
   8. The method of any preceding clause, wherein the intentionally vulnerable nodes are physically distributed around the network according to a social-based placement and/or a static placement.
   9. The method of any preceding clause, wherein physically locating the candidate malicious node in the network includes obtaining wireless RSSI measurements.
   10. The method of any preceding clause, wherein the method further includes sending periodic fingerprint updates from the nodes.
   11. The method of any preceding clause, wherein a candidate malicious node comprises a malicious mobile node and/or a victim node selected as a proxy that connects to a malicious mobile node external to the corporate network.
   12. The method of any preceding clause, wherein the method comprises isolating a detected candidate malicious node from the corporate network.
   13. The method of any preceding clause, wherein the method comprises disseminating code across nodes in the network which report interface activities to the intentionally vulnerable node.
   14. The method of any preceding clause, wherein the method comprises using a detection phase substantially as hereinbefore described and/or illustrated.
   15. The method of any preceding clause, wherein the method comprises using a tracking phase substantially as hereinbefore described and/or illustrated.
   16. The method of any preceding clause, wherein the method comprises using an isolation phase substantially as hereinbefore described and/or illustrated.
   17. A computer readable medium carrying instructions operable to execute one or more of the methods of any preceding clause.
   18. A mobile device carrying instructions operable to execute one or more of the methods of any preceding clause.

We propose HoneyBots, a MobiBot defense technique that leverages d2d communication to detect, track, and isolate malicious communications/attacks. Inspired by the success of HoneyPots, designed to isolate classical distributed denial of service (DDoS) botnet attacks using command and control (C&C) communication channel messages, HoneyBots' goal is way more challenging and requires more sophisticated techniques.

These techniques need to not only detect malicious communication between infected machines/bots, but also track back the malicious communication and locate the origin (e.g., the botmaster). The bots' mobility along with the distributed aspect of MobiBot attacks render classical HoneyPots unable to detect such sophisticated attacks.

The reason for this drawback is because MobiBots have a unique architecture that relies mainly on d2d wireless communication leveraging the fact that a mobile device within its intrinsic motion pattern makes frequent contact with entities that are capable of exchanging data or code. This architecture does not provide any pre-established command and control channel between a botmaster and its bots, ultimately rendering the detection and isolation of such botmasters extremely challenging.

HoneyBots operate in three phases. In the detection phase, the honeyBot operates in a vulnerable mode that allows malicious communication to pass through this node which helps detecting malicious behaviors. Once the honeyBot detects malicious communication, it moves to the tracking phase that allows the honeyBot node to infect malicious nodes and collect metadata about the path taken to disseminate attacks. The tracking phase's goal is to identify the origin of the attack. Once identified, the isolation phase starts. In this phase the honeyBot tries to potentially locate the botmaster node or the origin of the attack in order to isolate them and protect its network.

HoneyBots can be used to identify, track, and isolate malicious communication between mobile devices. They can be used as a product for all corporate IT administrators to monitor malicious communications and/or protect their network and infrastructure.

In some embodiments, this work consists of securing corporate networks from insider attacks such as BYOD attacks. It provides novel techniques that protect the network from Device-to-Device (d2d) malicious communication.

1) The MobiBot novel architecture for malicious d2d communication. This architecture opens doors for new sophisticated attacks that leverage vulnerable nearby devices and architectures to perform insider attacks.
2) The HoneyBot defence technique. It is inspired by HoneyPots that detect and help isolate classical botnet communication. Our technique helps detect novel malicious communication in disconnected d2d environments.

The HoneyBot will be a mobile application installed in a mobile device. We are implementing an android version of it. It consists of disseminating a piece of code across the network that allows all infected nodes to report their malicious activities to the HoneyBot. This application is then responsible for detecting malicious communication (using anomaly detection techniques) and track the malicious devices in order to isolate them and defend the network.

This technique will be considered as a generalized platform for detecting, tracking and isolating malicious communication for MobiBot networks. This platform will be used to test and implement different algorithm that detect, or track, or isolate such MobiBot communications.

Some embodiments are configured to provide a HoneyBot, a defense technique that detects, tracks, and isolates malicious device-to-device communication insider attacks. HoneyBots operate in three phases: detection, tracking, and isolation. In the detection phase, the HoneyBot operates in a vulnerable mode in order to detect lower layer and service-based malicious communication. We adopt a data driven approach, using real world indoor mobility traces, to evaluate the impact of the number of HoneyBots deployed and their placement on the detection delay performance. Our results show that utilizing only a few HoneyBot nodes helps detect malicious infection in no more than 15 minutes.

Once the HoneyBot detects malicious communication, it initiates the tracking phase which consists of disseminating control messages to help “cure” the infected nodes and trace back the infection paths used by the malicious nodes. We show that HoneyBots are able to accurately track the source(s) of the attack in less than 20 minutes.

Once the source(s) of the attack is/are identified, the HoneyBot activates the isolation phase that aims at locating the suspected node. We assume that the suspect node is not a cooperative device that aims at hiding its identity by ignoring all the Honeybot messages. Therefore, the HoneyBot requests wireless fingerprints from all nodes that have encountered this suspect nodes at a given time period. These fingerprints are used to locate these nodes and narrow down the suspect's location.

To evaluate our localization accuracy, we first deploy an experimental testbed where we show that HoneyBots accurately localize the suspect node within 4 to 6 m². HoneyBots can operate efficiently in small numbers, as few as 2 or 3 nodes while improving the detection, tracking, and the isolation by a factor of 2 to 3. We also assess the scalability of HoneyBots using a large scale mobility trace with more than 500 nodes.

A HoneyBot is a defense technique used to detect, track, and isolate malicious d2d communication. This technique consists of selecting a set of mobile devices/machines, called HoneyBot nodes (or HoneyBots). These nodes aim to (1) detect any malicious activity or insider attacks, and (2) coordinate with other neighboring nodes to track the malicious node or botmaster in order to isolate it.

In order that the present invention may be more readily understood, embodiments of the present invention are now described, by way of example, with reference to the accompanying drawings, in which:

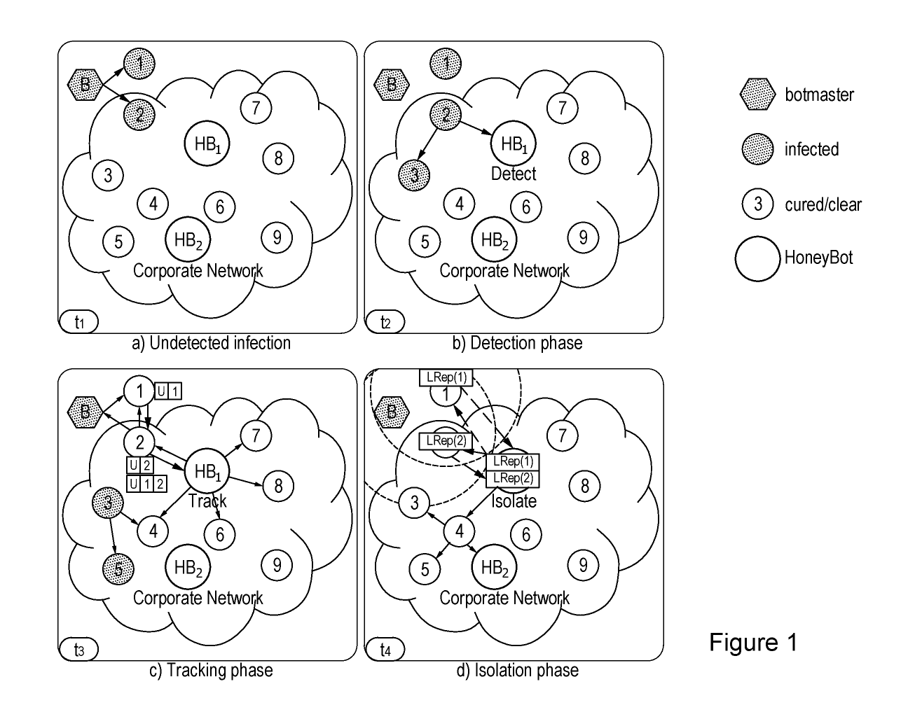

FIG. 1 is diagram showing a HoneyBot life-cycle consisting of detection (b), tracking (c) and isolation (d) techniques for MobiBot malicious attacks.

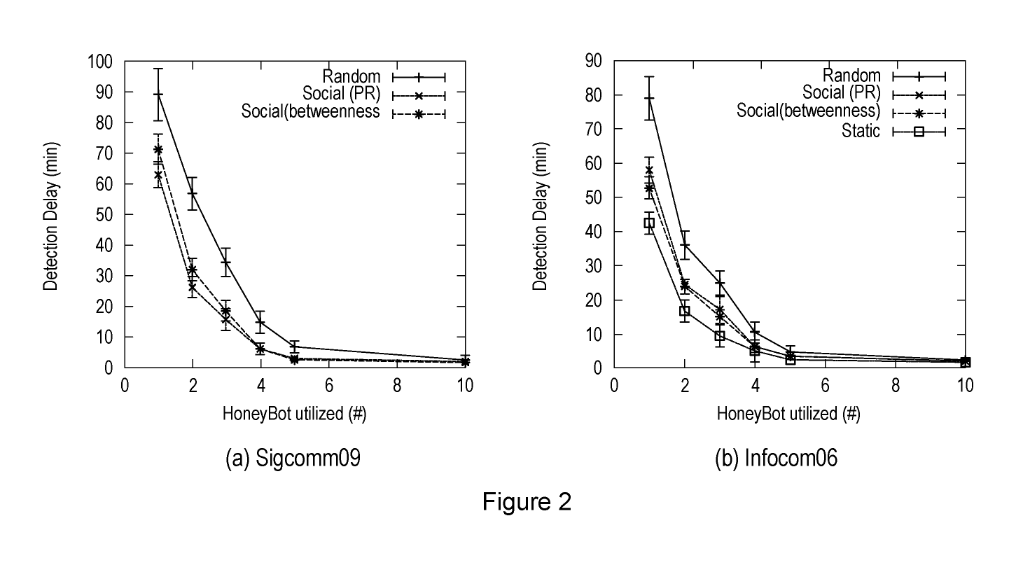

FIG. 2 shows graphs illustrating a comparison of different HoneyBot placement techniques on the detection delay using (a) Sigcomm09 and (b) Infocom06 traces.

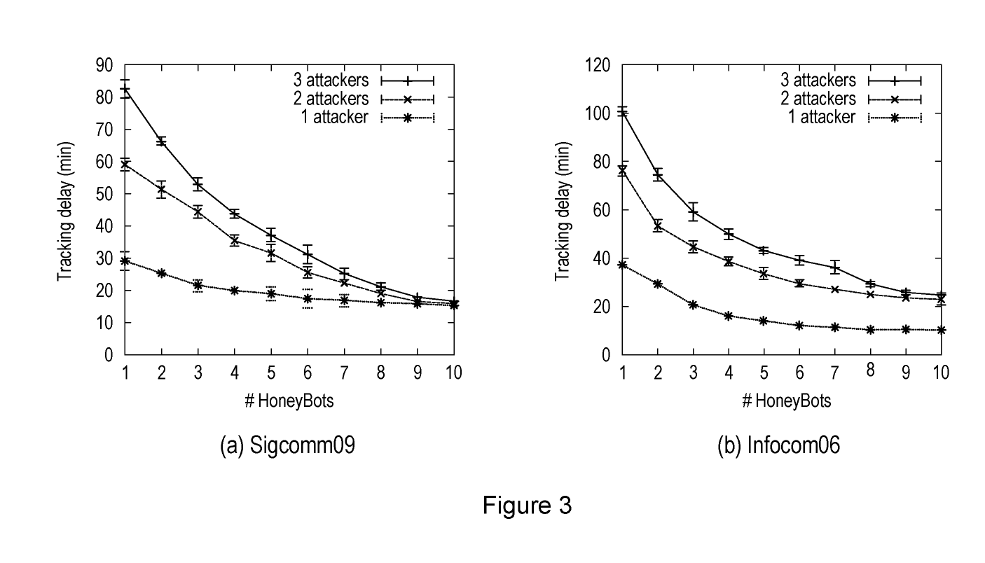

FIG. 3 shows graphs illustrating tracking delay measurements in function of the number and the placement of the HoneyBot nodes for (a) Sigcomm09 and (b) Infocom06.

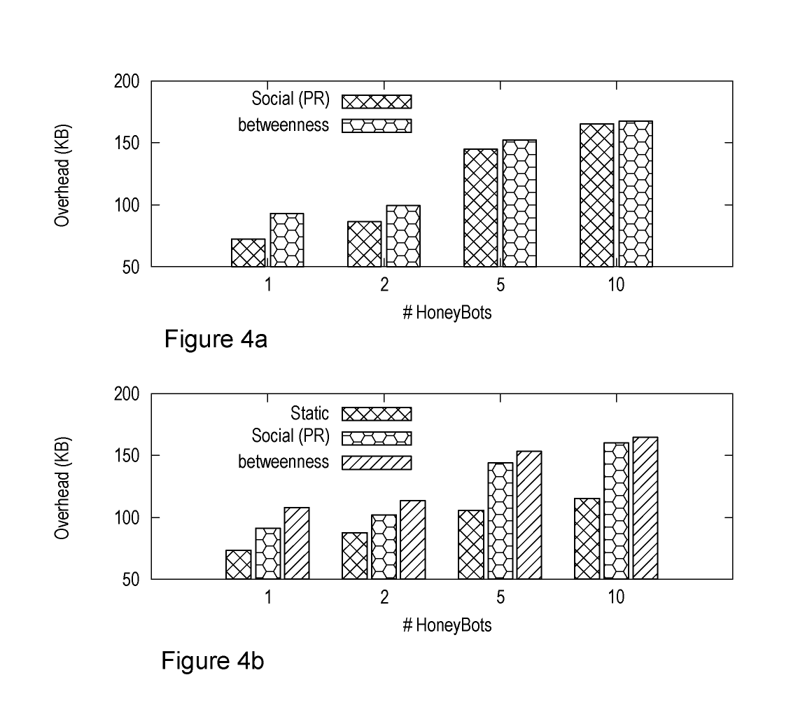

FIG. 4a shows a graph illustrating the overall tracking overhead injected in the network to detect 1 malicious node in Sigcomm09 traces.

FIG. 4b shows a graph illustrating the overall tracking overhead injected in the network to detect 1 malicious node in Infocom06 traces.

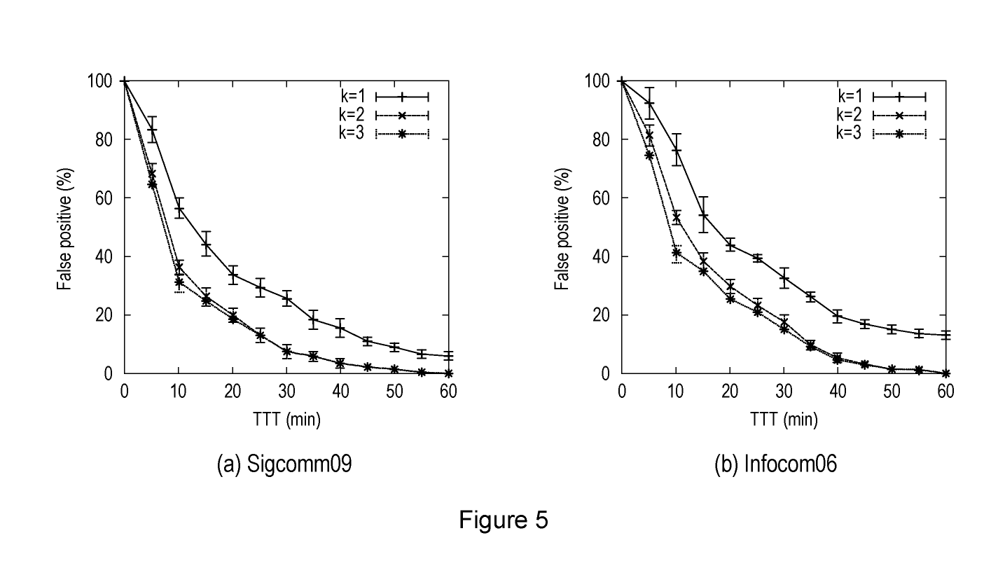

FIG. 5 shows graphs illustrating false positives given by our tracking heuristic in function of the time to track (TTT) deadline using (a) Sigcomm09 and (b) Infocom06 traces.

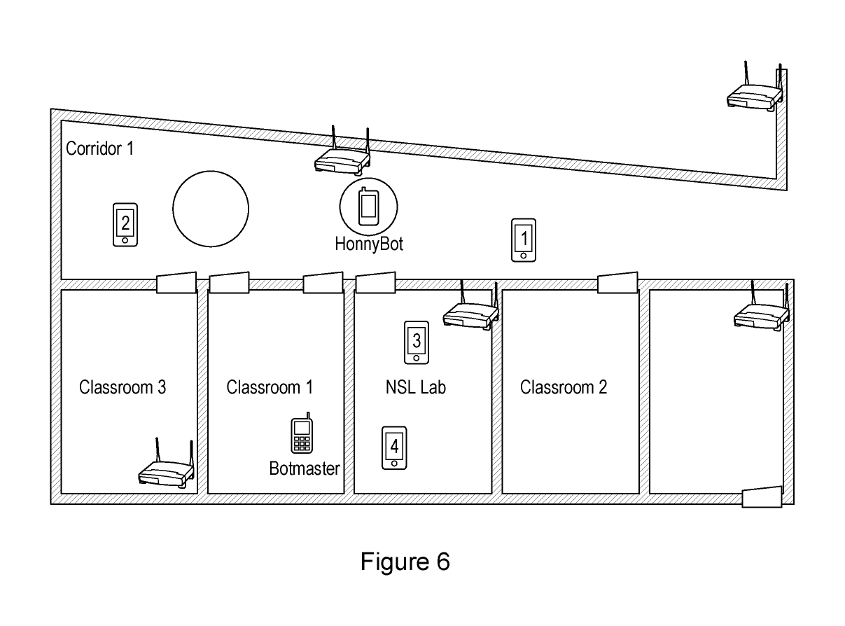

FIG. 6 is a diagram of the isolation phase experimental setup.

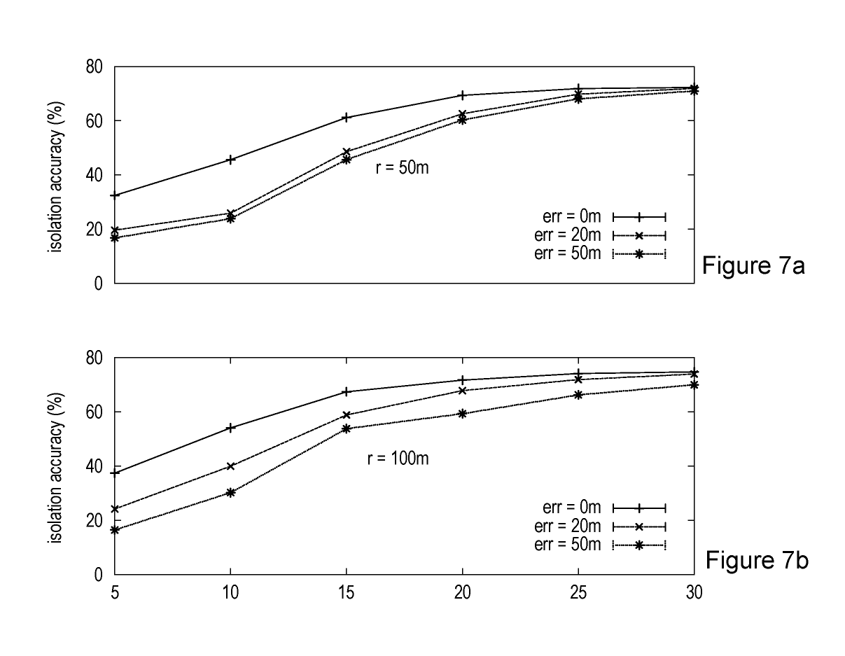

FIG. 7a shows a graph illustrating the isolation accuracy using the San Francisco taxi cab mobility trace when r=50.

FIG. 7b shows a graph illustrating the isolation accuracy using the San Francisco taxi cab mobility trace when r=100.

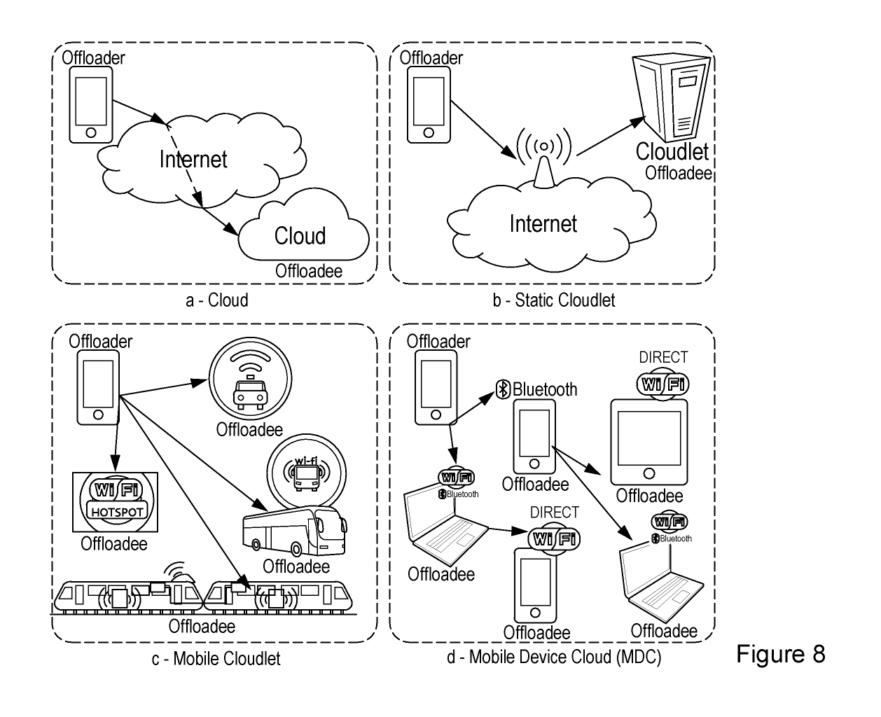

FIG. 8 is a diagram showing a cloud, a static cloudlet, a mobile cloudlet and a mobile device cloud (MDC).

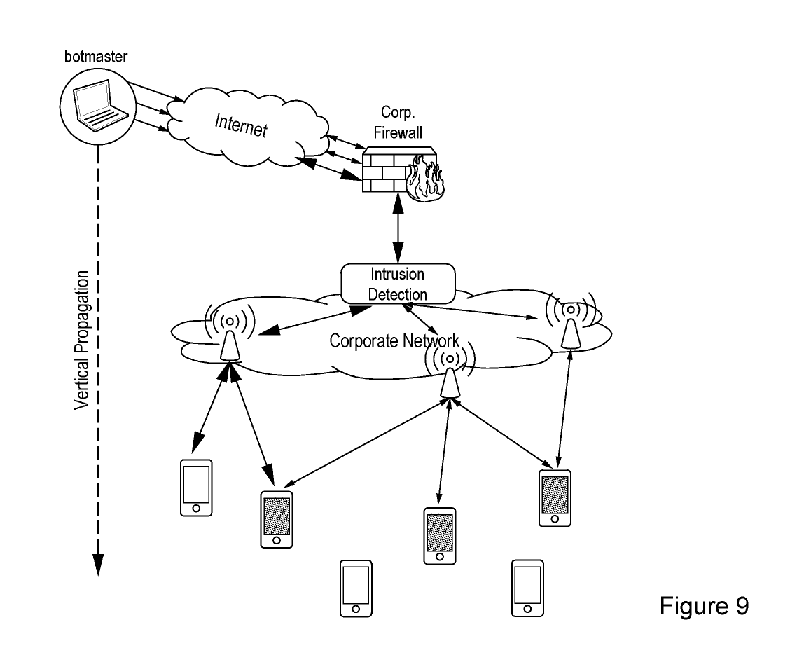

FIG. 9 is a diagram showing vertical propagation in a mobile botnet.

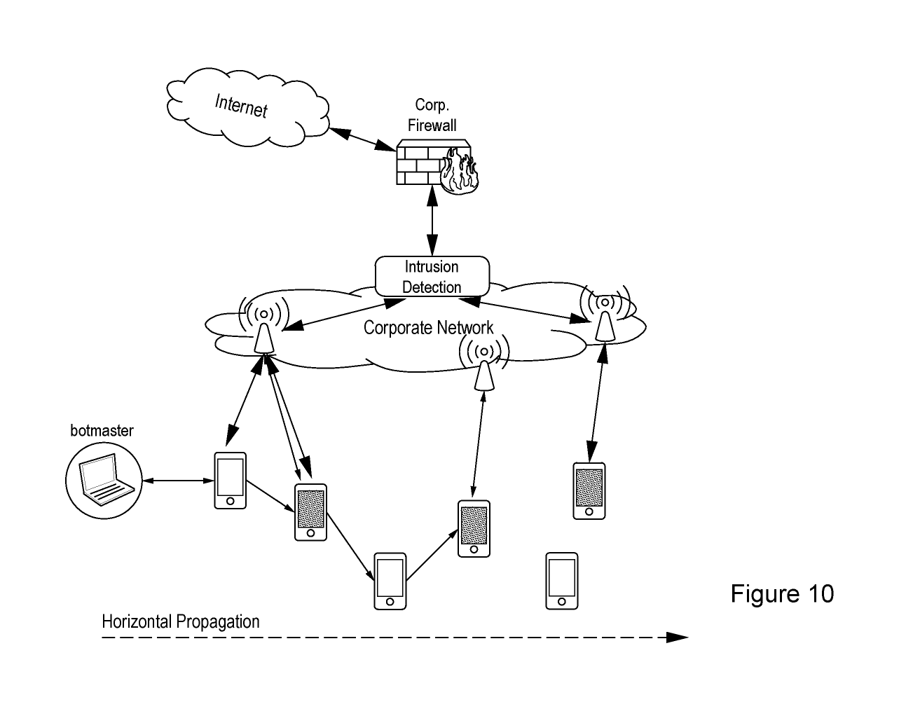

FIG. 10 is a diagram showing horizontal propagation in a mobile botnet.

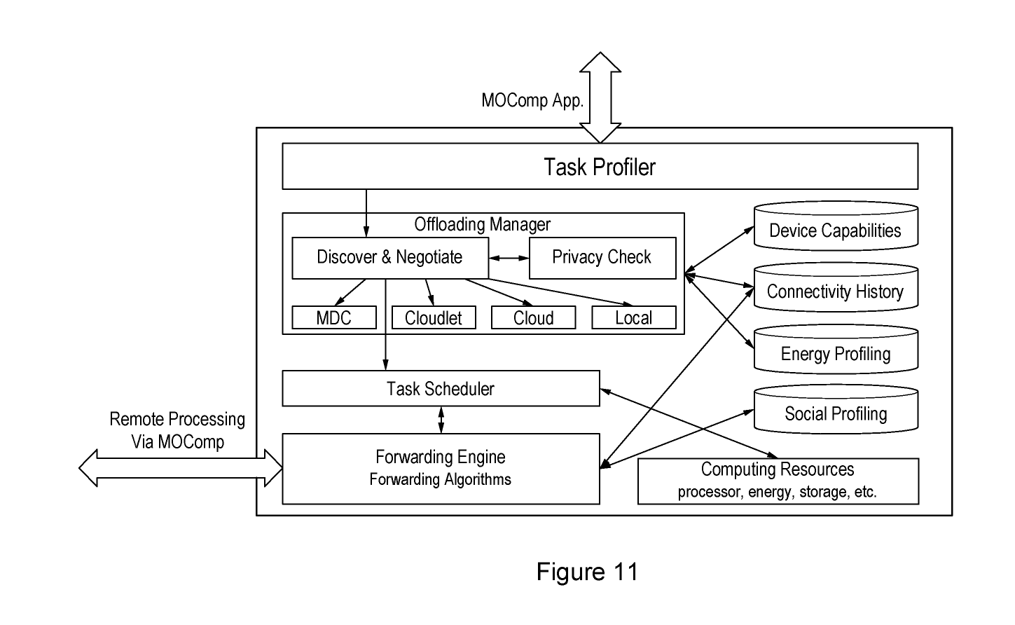

FIG. 11 is a diagram showing a d2d code offloading API.

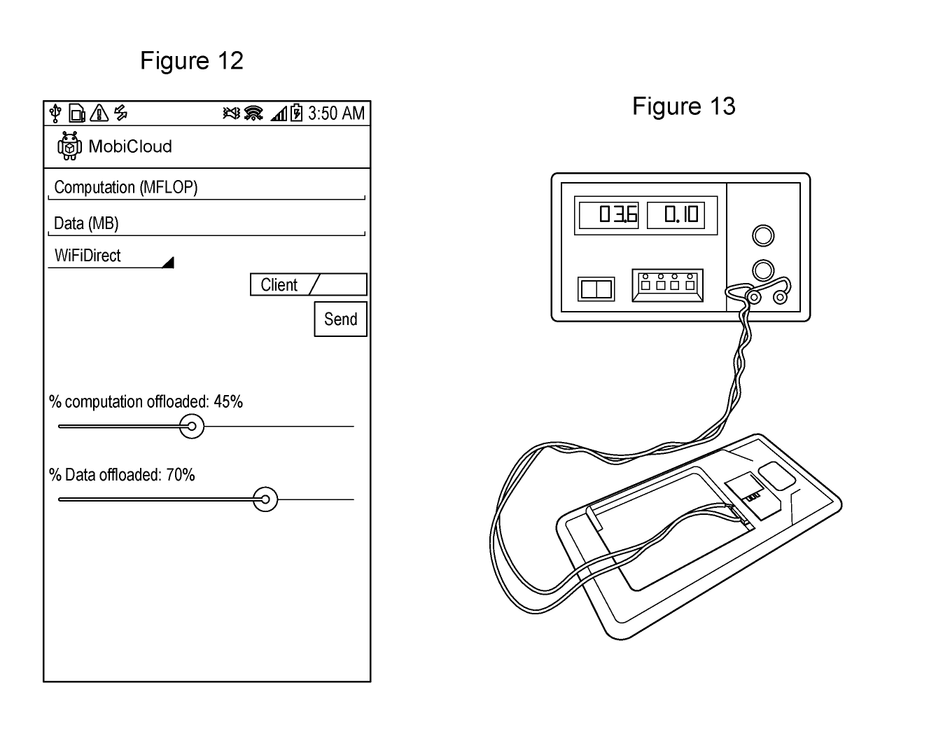

FIG. 12 shows an example screenshot of a mobile-to-mobile offloading Android™ app.

FIG. 13 is a diagram showing an energy measurement circuit example.

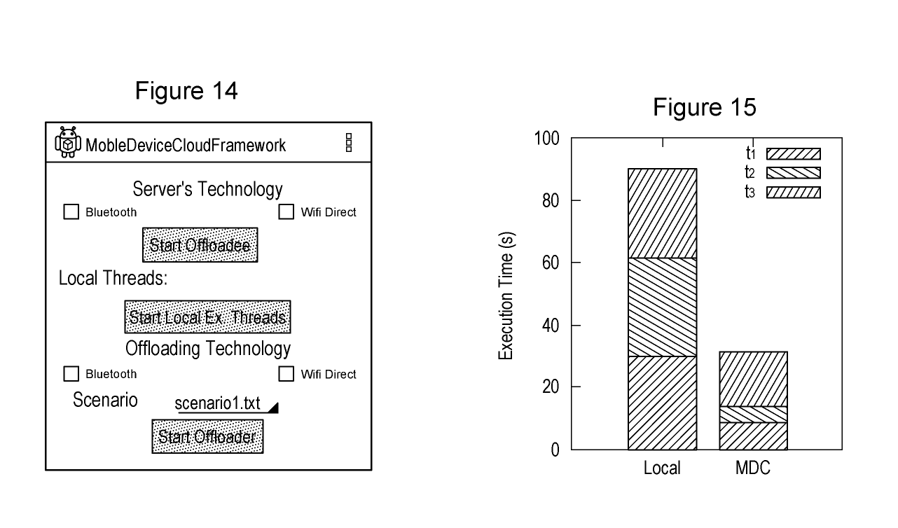

FIG. 14 is a diagram showing part of a screenshot of a mobile device cloud framework of one embodiment.

FIG. 15 is a graph showing the execution time for one embodiment.

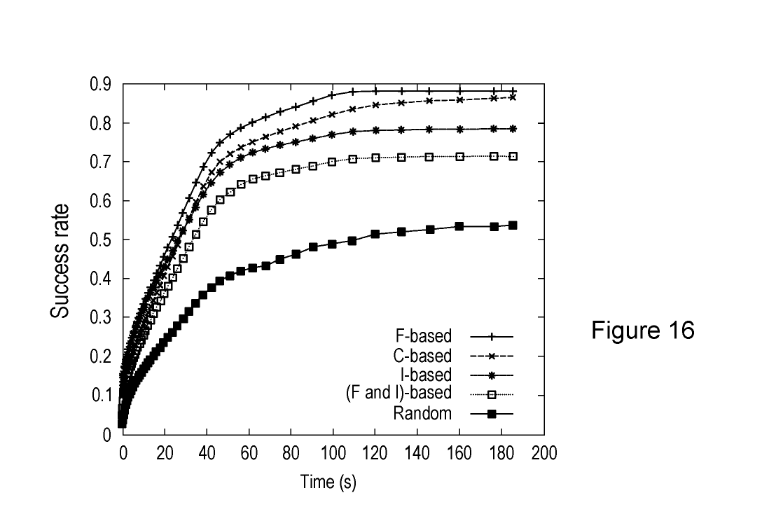

FIG. 16 is a graph showing the success rate over time for one embodiment.

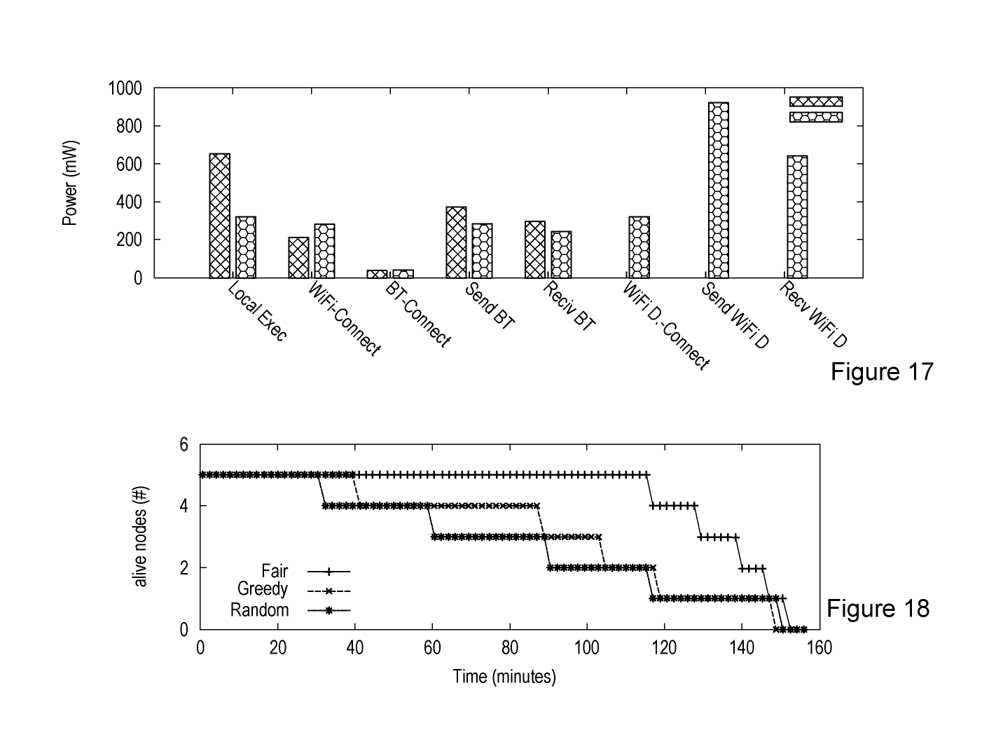

FIG. 17 is a graph showing a power example for one embodiment.

FIG. 18 is a graph showing the live nodes over time for one embodiment.

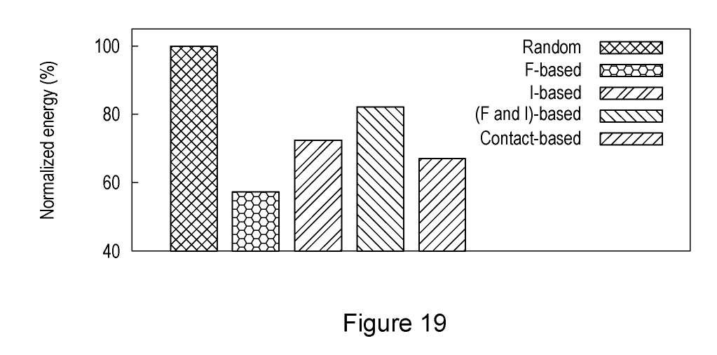

FIG. 19 is a graph showing a normalized energy example for one embodiment.

We consider, in FIG. 1, a scenario of a corporate network consisting of 9 vulnerable devices labeled 1 to 9. Such network is attacked by one or many botmaster nodes using d2d MobiBot communication. We notice that attacks are propagated horizontally, bypassing all Firewall and intrusion detection techniques deployed by the corporate network administrators.

In this scenario, we identify 3 main actors; the botmaster (hexagon B), the HoneyBot (circles HB₁ and HB₂), the infected bot (circles 1 and 2), and the cured or clear node (circles 3, 4, 5, 6, 7, 8 and 9). We assume that the 9 nodes shown in FIG. 1 only represent the vulnerable d2d nodes in this corporate networks.

We consider the following conservative assumption: A HoneyBot node can only coordinate with the cured/infected nodes to cure and isolate the attacks. We believe that activating additional nodes (e.g., adding dedicated secure nodes) can only improve the performance of this technique.

The HoneyBot's life-cycle consists of the following three main phases:

(i) Detection Phase: This phase aims at monitoring communication traffic and detecting potential malicious activities in the network. A HoneyBot node logs all exchanged messages across all interfaces. It monitors the low-layers and service based attacks. State-of-the-art intrusion detection techniques as well as anomaly detection methods can be deployed in d2d malicious communication.

In this phase, we investigate: (1) the number of HoneyBot nodes that a corporate network can deploy to efficiently detect malicious d2d communication in shorter delays, and (2) the impact of the placement of the mobile HoneyBot nodes in order to maximize the coverage and reduce detection delays. We investigate and compare two placement techniques, social-based and static placement.

(ii) Tracking Phase: This phase identifies the source of the attack by tracking back the paths used by the malicious messages exchanged. The HoneyBot node aims at reconstructing the paths used by the C&C messages and monitors the source and/or the destination of each path. We propose tracking heuristics and algorithms implemented at the HoneyBot nodes as well as the cured nodes to help tracking the suspect malicious nodes. We investigate the accuracy of these heuristic and the impact of the number of HoneyBots and their placement on the tracking efficiency.
(iii) Isolation Phase: This phase aims at physically localizing the position of the malicious node in order to isolate it. Localization is required to accurately identify the position of malicious nodes inside the corporate building and isolate them. We apply an indoor localization technique that consists of obtaining wireless RSSI measurements, and accurately locating each bot. Once the HoneyBot identifies one or many suspect nodes, it triggers the isolation phase. We identify two types of suspects, (1) a malicious mobile node (e.g., a botmaster), or (2) a victim node selected as a proxy that connects an external botmaster to the corporate network. After identifying a set of suspect nodes, the HoneyBot locates all neighbor nodes in order to identify the suspects' search areas.

### Detection Phase

This section investigates the detection techniques implemented by HoneyBots to identify d2d malicious communication.

Once an infection has been detected and identified, the HoneyBot launches countermeasures against infected devices in order to actively track and isolate the origin of the attack.

### Detection Approach

A HoneyBot constantly listens for any probes coming through all of its network interfaces. Wireless interfaces are more vulnerable to attacks. Intrusion detection techniques have been largely utilized to detect and classify normal and abnormal traffic/behavior at lower and higher layers [30].

While vulnerabilities exist across multiple layers, intrusion detection solutions operate at each layer. When a HoneyBot detects local intrusion such as abnormal system calls, it notifies lower layers in order to further investigate the intrusion. The HoneyBot is therefore responsible for monitoring and rating all incoming and outgoing flows and connections. Connections that score above a given threshold are flagged.

For simplicity, we assume that HoneyBots are dedicated mobile devices made seamlessly vulnerable by a corporate administrator to monitor abnormal behavior. Under this assumption, we monitor any outgoing flows at the HoneyBot node through all of its network interfaces. We therefore measure, detect, the detection delay, defined as the difference between the HoneyBot detection time, T_{detect}, and the botmaster attack starting time,

Tₛₜₐᵣₜ:δ_{detect}=T_{detect}−Tₛₜₐᵣₜ.

### Evaluation Approach

Our analysis relies on datasets collected in conference environments [21], [2]. These real world mobility traces consist of encounter logs using periodic Bluetooth scans. We focus our efforts on utilizing real behavior mobility traces, especially Bluetooth encounters, to efficiently assess short range device-to-device Bluetooth communication. In addition to human mobility information, these datasets contain social relationships between the experimentalists. We consider two datasets; Infocom06, and Sigcomm09. A summary of the corresponding parameters is given in Table I.

TABLE I
CHARACTERISTICS OF OUR EXPERIMENTAL DATASETS

| | Sigcomm09 | Infocom06 |
|---|---|---|
| duration | 3 days | 4 days |
| mobility patterns | Bluetooth contacts | Bluetooth contacts |
| device type | smartphone | iMote |
| coverage (m) | 10-20 | 30 |
| inquiry interval (s) | 120 ± 10.24 | 120 ± 5 |
| mobility | mobile | static + mobile |
| # nodes | 76 | 78 + 20(static) |

The Sigcomm09 dataset [21] consists of Bluetooth contact discovery logs and data communications between the participants. Up to 100 participants during the SIGCOMM 2009 conference were involved in this experiment. This trace was based on an opportunistic mobile social networking application, called MobiClique, that collects social data between the participants. It gathers and updates interest and friendship data related to the participants. We have created two subtraces; one coupling mobility with interests and the other coupling mobility with friendship. This dataset was collected using Windows Mobile devices that were given to a set of participants on the first day of the conference. Each device was used for an average of 2.65 days since people arrived and left at different times.

The Infocom06 dataset [2] was collected with 78 participants and 20 fixed base stations during the IEEE Infocom 2006 conference. People were asked to carry an experimental device, an iMote, with them all time. These devices were logging all contacts between participating devices using a periodic scanning every 2 seconds. In addition, they logged connections established with other long range static Bluetooth Motes localized in strategic places such as welcome desks, elevators, and conference rooms. Questionnaires were given to participants to fill theirs nationalities, languages, countries, cities, academic affiliations and topics of interests.

### Detection Results

We believe that HoneyBot's detection performance at any time t depends on the number of infected bots bt at time t, the number of HoneyBots H deployed in the network and their displacement D in the network area. We investigate the impact of these parameters on the MobiBot infection detection performance.

We plot, in FIG. 2, the detection delay detect when 1, 2, 3, 4, 5 and 10 HoneyBots are placed in the network using both traces Sigcomm09 (FIG. 2(a)) and Infocom06 (FIG. 2(b)). Each data point in the figure is an average of at least 15 runs within which the HoneyBot and the botmaster are selected randomly from the list of nodes in the trace. We plot a 97% confidence interval to highlight the distribution across multiple runs. FIG. 2 compares different HoneyBot placement heuristics: Random, Social, and Static.
Random selection consists of selecting random HoneyBot nodes from the list of nodes in the dataset (experiment was repeated 10 times and detect plotted represents an average of these 10 runs).
Social selection consists of ranking the social importance of the nodes in the dataset. We select the best ranked first. For instance, when 5 HoneyBots are deployed, we select the nodes ranked from 1 to 5 as the best 5 social nodes. We consider two ranking metrics: (1) using the PeopleRank (PR) algorithm [20]. (2) using the betweenness centrality metric.
Static selection involves placing nodes in particular landmarks in the considered area such as elevators, lunch rooms, and conference rooms. Such placement makes HoneyBots more suitable to meet more nodes.

FIG. 2 shows that regardless of the HoneyBot selection technique used, detection delay is reduced when the number of deployed HoneyBots increases. This gain is significantly higher when we use 2 or 3 HoneyBots compared to 1, where the delay is reduced to 20 minutes compared to 68 minutes when only one HoneyBot is deployed. In fact, detection is 50% faster when two HoneyBots are deployed. However, utilizing more than five HoneyBots does not show significant delay reduction; the detection time is only reduced by a few minutes when 10 Honeybots are deployed compared to only 5.

In addition, we show that social selection outperforms random selection by up to 47% improvement when 2 HoneyBots are utilized in the Sigcomm09 dataset. This shows that HoneyBot placement has a direct impact on the detection delay performance. As stated in many social opportunistic research, socially important nodes have higher probability to meet other nodes [19], [12], [20].

While social selection shows better results compared to random selection, this technique remains impractical since HoneyBots are designed to be dedicated nodes (or bots) which deprives them from having social relationships in the network. However, static selection, besides its practicality, seems to achieve the best detection delay outperforming even the social selection schemes. The static placement technique, therefore, helps achieve up to 35% improvement compared to the detection delay performance measured by a socially selected HoneyBot. Static HoneyBots are able to detect malicious communication in less than 20 minutes when only 2 HoneyBots are placed in the Infocom06 dataset.

### Tracking Phase

Once malicious d2d communication is detected successfully, the HoneyBot starts the tracking phase. While malicious communication in the network can be easily and efficiently identified, tracking the origin of such communication is a challenging research problem for the following reasons: (1) in d2d communication the IP address of the source cannot be determined since all sending nodes can be considered as sources of the same message. (2) The mobility of the nodes makes dynamic paths which are hard to track over time. Therefore, reconstructing the path taken by a given message is not trivial. (3) Physically identifying and locating the attacking source (i.e., botmaster) within the enterprise area is another challenging research problem.

In this section, we propose a HoneyBot tracking algorithm that consists of crowdsourcing the tracking task to a set of encountered nodes that help identify the attacking node. We present the tracking algorithm at the HoneyBot (Hb) node (i.e., Alg. 1) and the one implemented at the cured (Cured) node (i.e., Alg. 2). Afterward, we present an evaluation performance of these algorithms and discuss their efficiency using the two real world datasets described earlier.

### Tracking Algorithms

In the tracking phase, the botmaster first broadcasts a purge msg to all of its neighbors in order to (1) cure the infected nodes, and (2) utilize additional nodes (resources) to extend the search area and speedup the identification of the source of the attack. Alg. 1 presents the pseudo-code of the HoneyBot detection and tracking algorithm. In the detection phase, the HoneyBot identifies the interface (i), the port (PORT) and the protocol (TCP|UDP) used by the malicious communication. This triplet is stored and used as a means to track the path of the identified malicious communication. Therefore, the HoneyBot communicates using the same vulnerable channel and disseminates its purge msg to all the nodes in the network. It maintains a list of suspect nodes (suspect) that initially contains all nodes in the network.

Nodes are then removed from the list if the HoneyBot is able to cure them. Eventually, the process converges where only 1 or few node suspects remain in the list. We investigate the required convergence time in the following sections.

Nodes which receive the purge msg message, as shown in Alg. 2, get notified with a potential infection. Therefore, they are requested to allow the HoneyBot to install (or activate) a third party service which is the Node Tracking algorithm described in Alg. 2. Such service cures these nodes and helps the HoneyBot node (Hb) in the tracking process by forwarding the purge msg to other neighbors. Cured nodes are also responsible for periodically updating the requesting HoneyBot by a private message consisting of a list of cured nodes (i.e., purge msg). Hence, the HoneyBot identifies the nodes that do not participate in the tracking process: i.e., nodes receiving the purge msg without forwarding it to their neighbors within a deadline called Time-To-Track (TTT).

Beyond the TTT deadline, these nodes are considered suspects and will be further investigated in the isolation phase. We tune this parameter as it represents a major factor impacting the efficiency and speed of the tracking process. In fact, shorter TTT values makes the algorithm converge faster, but identifies many suspects that may not be responsible for such malicious communication and vice versa.

Alg. 1 and Alg. 2 are distributed and decentralized. They leverage short range wireless technologies, such as Bluetooth, to track the source of the malicious communication and identify a set of suspect nodes. The tracking algorithm is a heuristic approach that consists of flooding the network to search for malicious sources. However, this heuristic does not guarantee an accurate tracking of these sources. This will be investigated in the following section, where we quantify the false positives given by the algorithm and discuss its accuracy.

### Tracking Phase

Crowdsource to encountered nodes, identify fast & accurately
Step1: Cure infected nodes,
   identify the infected interface (i)
      PORT, protocol (TCP/UDP) used
   Broadcast purge_msg
Step2: cured nodes crowdsourcing
   Update suspect list
   Forward purge_msg, send replies to HB
HB identifies a set of suspect nodes
   After a Time To Track (TTT)

### Tracking Algorithms

### Alg1: @HB

Detection: intrusion detection
Identify suspect nodes
Cure infected nodes
Purge the network
   Alg2: @nodes
Help the HB forwarding/curing/identifying
Run upgrade to cure the node

Algorithm 1 HoneyBot (Hb) Tracking

Require: ACTORS = Infected, Cured, Hb

| | |
|---|---|
| 1: | while 1 do |

| | |
|---|---|
| 2: | if Hb receive_msg(j,msg,i,TCP\|UDP,PORT) then |

| | |
|---|---|
| 3: | if j == infected then |

| | |
|---|---|
| 4: | intrusion_detection(i,TCP\|UDP,PORT,node) |
| 5: | save(i,TCP\|UDP,PORT) |

| | |
|---|---|
| 6: | end if |
| 7: | if j == cured then |

| | |
|---|---|
| 8: | if msg == purge_msg then |

| | |
|---|---|
| 9: | suspect ← DeQueue(PATH) |
| 10: | wiat_to_pronounce(suspect,TTT) |
| 11: | for all binPATH do |

| | |
|---|---|
| 12: | if b == suspect then |

| | |
|---|---|
| 13: | kill(wait_to_pronouce(suspsect,TTT)) |

| | |
|---|---|
| 14: | end if |
| 15: | b ← cured |

| | |
|---|---|
| 16: | end for |

| | |
|---|---|
| 17: | end if |

| | |
|---|---|
| 18: | end if |

| | |
|---|---|
| 19: | end if |
| 20: | if Hb in_contact_with j then |

| | |
|---|---|
| 21: | if j == infected then |

| | |
|---|---|
| 22: | patch(j,i,TCP\|UDP,PORT) |
| 23: | cure(j,i,TCP\|UDP,PORT) |
| 24: | send(j,purge_msg(k,TTT)) |
| 25: | j ← cured |

| | |
|---|---|
| 26: | end if |
| 27: | if j == cured then |

| | |
|---|---|
| 28: | send(j,purge_msg(k,TTT)) |

| | |
|---|---|
| 29: | end if |

| | |
|---|---|
| 30: | end if |

| | |
|---|---|
| 31: | end while |

Algorithm 2 Tracking by a Cured node (n)

| Require: ACTORS = node, Hb | |
|---|---|
| 1: | while 1 do |

| | |
|---|---|
| 2: | if n receive_msg(j,msg,i,TCP\|UDP,PORT) then |

| | |
|---|---|
| 3: | if j == Hb then |

| | |
|---|---|
| 4: | notify(user) |
| 5: | ask_permission(patch) |

| | |
|---|---|
| 6: | end if |
| 7: | if j == node then |

| | |
|---|---|
| 8: | if msg == purge_msg then |

| | |
|---|---|
| 9: | append_IP(PATH,msg) |
| 10: | forward_To_All(msg) |

| | |
|---|---|
| 11: | end if |

| | |
|---|---|
| 12: | end if |

| | |
|---|---|
| 13: | end if |

| | |
|---|---|
| 14: | end while |

### HoneyBot Tracking Performance

Our tracking analysis is also based on the two datasets described earlier: Infocom06 and Sigcomm09. We measure the tracking delay defined as the difference between the time required to identify the first suspect and the start time of the tracking phase. In addition to the position of the HoneyBot, the tracking delay performance depends on other major parameters such as the number of attackers (i.e., suspect nodes) and the number of HoneyBots deployed in the area. We choose to fix the HoneyBot placement technique based on our previous detection analysis (i.e., Static for Infocom06, and Social for Sigcomm09) and investigate the impact of the number of HoneyBots on tracking delay.

1) Tracking Delay & Overhead: We plot, in FIG. 3, the tracking delay in minutes as a function of the number of HoneyBots deployed in (a) the Sigcomm09, and (b) Infocom06 datasets. We compare the tracking delay performance when 1, 2 and 3 attacker nodes are utilized. All data points are measured as an average of at least 15 runs; in each run, the attacker nodes and/or the Honeybbots are selected randomly from the considered dataset. We also plot the 97% confidence intervals associated with each experiment run.

Similar to the detection delay, the tracking delay decreases when the number of deployed HoneyBots increases. However, the non increasing curve is almost linear, especially in the Sigcomm09 dataset as opposed to the curve of the detection delay where we show that adding only few HoneyBots helps reduce the detection delay by a factor of 2.

This can be explained by the fact that tracking requires the reception of multiple packets from multiple nodes by the same HoneyBot node, which always requires an additional delay that cannot be significantly minimized by adding multiple HoneyBots.

In fact, adding multiple socially important HoneyBots does not necessarily imply reducing the area of search because all these HoneyBots tend to move towards dense areas and may not cover all corner cases. However, we show that static placement of the HoneyBots helps reduce the delay by optimizing the search areas. We show that when only 4 HoneyBots are deployed, the tracking delay can be reduced by half compared to tracking delay measured by only one utilized HoneyBot.

Moreover, we show that the tracking delay increases when the number of attacker nodes increases. However, the impact of the number of attacker nodes deployed is insignificant beyond 2 attacker nodes. This is due to the fact that the tracking algorithm converges with a list of suspects regardless of the size of the list. However, some nodes in the list can be identified sooner than others (e.g., closer to the HoneyBot).

In addition to the tracking delay, the overall overhead introduced by our tracking technique represents an important performance metric. In fact, this overhead is directly related to the additional energy consumption introduced by such techniques. We measure the overall overhead as the number of messages introduced to the network until the identification of a suspect node.

We plot the overhead introduced while using different HoneyBot placement techniques in FIG. 4. First, we show that the overhead introduced does not exceed 150 to 180 KB in both considered traces. This represents no more than 2 Joules consumed by the technique [13]. Second, we show that static placement also reduces the overall overhead by a factor of 2 in the Infocom06 trace. As described above, static placement helps identify suspect nodes faster, and therefore reduces the overhead. Finally, among the social placement techniques, the PeopleRank placement is outperforming the betweenness centrality technique especially when fewer HoneyBots are deployed in the network.

2) Tracking Accuracy: We now empirically investigate the accuracy of our tracking heuristic. We consider possible HoneyBot and attacker placement combinations on our datasets.

Then, we measure the false positive ratio defined as the percentage of nodes that are misidentified as suspects.

FIG. 5 plots the false positive ratio as a function of the time to track TTT values utilized in both (a) Sigcomm09, and (b) Infocom06 datasets. Obviously, when the TTT increases, the false positive ratio considerably decreases. In fact, small TTT values imply that all nodes will be 1 or 2 hops away from the HoneyBot which can be unrealistic. We show that a half hour TTT reduces the false positive ratio to less than 10% in the sigcom09 dataset. TTT values of 50 minutes reduces the false positives to almost zero percent in both datasets. We believe that the TTT parameter is important and can be tuned by a corporate network administrator based on the security level that he/she wants to ensure.

To further reduce false positives, a HoneyBot sends multiple purge messages (k) to increase the dissemination of such message and better cover the considered area. We show that when only 1 purge message is utilized, the false positive ratio is relatively high (30% when TTT=30). This is mainly due to suspected nodes that were not able to meet other nodes and forward the purge message within the TTT deadline. However, when k=2, when 2 different nodes report that another node is not forwarding the purge message, the HoneyBot's decision can be made faster and with higher efficiency. In fact, due to bidirectional links used in the experiment, whenever a second node meets a suspect node without receiving a purge message from it, the HoneyBot can efficiently identify this suspect as a potential attacker.

### Isolation Phase

The isolation phase consists of accurately localizing the malicious node(s) inside or outside the corporate building and isolating it (them). Indeed, localization represents an important step towards isolating malicious nodes. Once localized, the botmaster can be physically controlled and isolated.

### Isolation Method

Isolation requires high-granularity indoor localization. Due to GPS limitations in indoor environments, many indoor localization systems using WiFi received signal strength indicator (RSSI) updates, GSM signal readings, short range scans via Bluetooth, Infrared, UWB or RFID readings, were introduced [16]. With the ubiquitous aspect of WiFi, we believe that WiFi-based indoor localization is the most attractive technique due to its reliance on a ubiquitously deployed infrastructure especially in corporate networks. In addition, WiFi localization performs well in indoor environment reaching up to 0.5 m localization accuracy in some systems.

WiFi localization requires sending periodic fingerprint (i.e., RSSI) updates from the nodes. In the isolation phase, upon identifying a set of malicious suspects, HoneyBots send a localization request (LReq) to all neighbor nodes surrounding each attacker suspect. Neighbors are within Bluetooth range (i.e., 5 to 10 meters) of the attacker suspect. LReqs are sent in unicast only to nodes surrounding the attacker candidates.

These nodes reply with a LRep message consisting of their best RSSI fingerprints to at least 3 disjoint APs. LReps are also sent in unicast to the requesting HoneyBot which, upon receiving all LReps from all neighbors, runs an indoor localization scheme such as RADAR [1] to locate all neighbors, and with a simple triangulation technique, narrows down the search area for the botmaster suspect.

### Proof-of-Concept Experimentation & Analysis

We implement P-Loc, a generic indoor localization system running on the HoneyBot machine. P-Loc, similar to RADAR [1], selects the closest surveyed (a priori) position based on the RSSI readings. Each corporation is responsible for surveying the area accurately using different devices (i.e., network interfaces). We consider a lab testbed environment, shown in FIG. 6, located on the second floor of our building.

The considered area consists of a research lab and a set of classrooms. The area is pre-surveyed using RSSI readings from 2 Samsung S3 and S4 devices for every 3-4 meters.

We consider the following scenario shown in FIG. 6 which is a lab environment with 5 nodes and 1 attacker. The accuracy is 1 to 2.5 meters. FIG. 6 shows where the botmaster is located in classroom 1. The HoneyBot, upon suspecting malicious activity in nodes 3 and 4's vicinity, sends a LReq to both nodes 3 and 4 (i.e., located in a room adjacent to classroom 1). Nodes 3 and 4 reply with LRep consisting of their RSSI fingerprints to the requesting HoneyBot. The HoneyBot localizes both nodes 3 and 4 and computes the search zone for the suspect botmaster.

We run the experiment with P-Loc implemented on all 4 android devices; two Nexus 7, and two Galaxy Nexus devices. The HoneyBot, a Nexus 5 android device, implements a P-Loc server that displays a map of a campus building where located nodes are shown in circles. We change the position of both the HoneyBot and the botmaster and measure the localization accuracy error given by P-Loc to locate allbotmaster neighboring devices and the accuracy of the search area measured by the HoneyBot. Our results show that on average, P-Loc succeeds in locating nodes with only 1 to 2.5 meters accuracy errors. This helps achieve up to 85% accuracy in locating the botmaster nodes. In fact, errors in locating neighbor nodes in a direction or another induce a probability of mis-computing the search area by the HoneyBot. This can be improved by adding a confidence factor that helps incorporate such error in computing the search area (i.e., by widening the search area).

### Large Scale Evaluation

Our proof-of-concept experiment represents a first step towards evaluating the accuracy of the localization and isolation techniques. As a next step, we evaluate our algorithm using a larger scale dataset. With the absence of accurate indoor localization traces, we consider an outdoor taxi cabs trace in San Francisco [22]. It contains GPS coordinates of approximately 500 taxis collected over 30 days. We select only 486 taxis that have consistent GPS records over 10 days.

Each trace contains the reported time and location for each Cab in latitude and longitude. We take these traces for the duration of 10 days, interpolate the movement of the cabs, and then generate the contacts between the cabs. We consider the communication range of each cab to be 50 or 100 meters; i.e., a contact has occurred when a cab comes in proximity of r=50 or r=100 meters of another cab.

We vary the number of HoneyBots deployed in the experiment. We assume that there is only 1 attacker node in each experiment. We repeat the experiment 20 times. In each run, we randomly place the attacker node. We therefore measure the isolation accuracy as the number of times we efficiently locate the attacker in the 50 considered runs. Errorbars represent the 97% confidence interval based on (1) the 20 random placements of the attacker node and (2) at 15 random placements of HoneyBot nodes in all three areas of San Francisco (bay, airport, and sunset areas). We ensure that the number of HoneyBots in each area is constant.

FIG. 7 shows that the accuracy increases when the number of HoneyBots deployed increases. In fact, when only few HoneyBots are deployed, the average path length increases which translates to an increase in the LReq and LRep delivery delays. This heavily impacts the localization accuracy. However, the density of the network (r=100) seems to not impact the accuracy considerably (gain does not exceed 10%). We also compare our isolation technique when the localization scheme deployed has a predefined error (err=30 meters, and err=50 meters). We show that the accuracy error impacts the isolation performance when the number of HoneyBots is low.

HoneyBots is a novel defense technique for malicious device to device (d2d) communication. It consists of detecting, tracking, and isolating malicious activity in a d2d disconnected opportunistic network such as MobiBots.

We have presented algorithms, heuristics and experimental analysis on each phase. Our accuracy and efficiency evaluation were based on real world mobility traces. We have shown that the placement of the HoneyBot nodes as well as their number considerably impact speed and accuracy measurements. HoneyBots can operate efficiently in small numbers, as few as 2 or 3 nodes while improving detection, tracking, and the isolation by a factor of 2 to 3.

This work is a first step towards implementing a proof-of-concept prototype (embodiment) of HoneyBots and evaluating its performance on real corporate or university networks.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

### REFERENCES

[1] P. Bahl and V. N. Padmanabhan. RADAR: An Inbuilding RF-based User Location and Tracking System. In InfoCom, 2000.
[2] A. Chaintreau, A. Mtibaa, L. Massouli'e, and C. Diot. The diameter of opportunistic mobile networks. In Proceedings of ACM CoNext, 2007.
[3] H. Choi, H. Lee, and H. Kim. Botgad: detecting botnets by capturing group activities in network traffic. In Proceedings of the Fourth International ICST Conference on COMmunication System softWAre and middlewaRE, page 2. ACM, 2009.
[4] B.-G. Chun, S. Ihm, P. Maniatis, M. Naik, and A. Patti. Clonecloud: elastic execution between mobile device and cloud. In Proceedings of the sixth conference on Computer systems, EuroSys '11, pages 301-314, New York, N.Y., USA, 2011. ACM.
[5] E. Cuervo, A. Balasubramanian, D. ki Cho, A. Wolman, S. Saroiu, R. Chandra, and P. Bahl. Maui: making smartphones last longer with code offload. In MobiSys'10, pages 49-62, 2010.
[6] H. Deng, W. Li, and D. Agrawal. Routing security in wireless ad hoc networks. Communications Magazine, IEEE, 40(10):70-75, October 2002.
[7] M. Eslahi, R. Salleh, and N. B. Anuar. Mobots: A new generation of botnets on mobile devices and networks. In Computer Applications and Industrial Electronics (ISCAIE), 2012 IEEE Symposium on, pages 262-266. IEEE, 2012.
[8] J. Flinn. Cyber foraging: Bridging mobile and cloud computing. Synthesis Lectures on Mobile and Pervasive Computing, 2012.
[9] K. Habak, M. Ammar, K. A. Harras, and E. Zegura. Femtoclouds: Leveraging mobile devices to provide cloud service at the edge. In IEEE Conference on Cloud Computing (IEEE CLOUD), 2015.
[10] A. Kate, G. Zaverucha, and U. Hengartner. Anonymity and security in delay tolerant networks. In Security and Privacy in Communications Networks and the Workshops, 2007. SecureComm 2007. Third International Conference on, pages 504-513, September 2007.
[11] J. Levine, R. LaBella, H. Owen, D. Contis, and B. Culver. The use of honeynets to detect exploited systems across large enterprise networks. In Information Assurance Workshop, 2003. IEEE Systems, Man and Cybernetics Society, pages 92-99. IEEE, 2003.
[12] A. Mtibaa, A. Chaintreau, J. LeBrun, E. Oliver, A.-K. Pietilainen, and C. Diot. Are you moved by your social network application? In WOSN'08: Proceedings of the first workshop on Online social networks, pages 67-72, New York, N.Y., USA, 2008. ACM.
[13] A. Mtibaa, A. Fahim, and K. A. Harras. Towards computationl offloading in mobile device clouds. In Cloud Computing Technology and Science (CloudCom), 2013 IEEE 5th International Conference on, December 2013.
[14] A. Mtibaa, A. Fahim, K. A. Harras, and M. H. Ammar. Towards resource sharing in mobile device clouds: Power balancing across mobile devices. In Proceedings of the second ACM SIGCOMM workshop on Mobile cloud computing, pages 51-56. ACM, 2013.
[15] A. Mtibaa, K. Harras, and H. Alnuweiri. From botnets to mobibots: a novel malicious communication paradigm for mobile botnets. Communications Magazine, IEEE, 53(8):61-67, August 2015.
[16] A. Mtibaa, K. A. Harras, and M. Abdellatif. Exploiting social information for dynamic tuning in cluster based wifi localization. In Wireless and Mobile Computing, Networking and Communications (WiMob), 2015 IEEE 11th International Conference on. IEEE, 2015.
[17] A. Mtibaa, K. A. Harras, and H. Alnuweiri. Malicious attacks in mobile device clouds: A data driven risk assessment. In Computer Communication and Networks (ICCCN), 2014 23rd International Conference on, pages 1-8. IEEE, 2014.
[18] A. Mtibaa, K. A. Harras, K. Habak, M. Ammar, and E. W. Zegura. Towards mobile opportunistic computing. In Cloud Computing (CLOUD), 2015 IEEE 8th International Conference on, pages 1111-1114, June 2015.
[19] A. Mtibaa, M. May, and M. Ammar. On the relevance of social information to opportunistic forwarding. Modeling, Analysis, and Simulation of Computer Systems, International Symposium on, 0:141-150, 2010.
[20] A. Mtibaa, M. May, M. Ammar, and C. Diot. Peoplerank: Social opportunistic forwarding. In Proceedings of IEEE INFOCOM. IEEE, 2010.
[21] A.-K. Pietil''ainen, E. Oliver, J. LeBrun, G. Varghese, and C. Diot. Mobiclique: middleware for mobile social networking. In Proceedings of the 2nd ACM workshop on Online social networks, pages 49-54. ACM, 2009.
[22] M. Piorkowski, N. Sarafijanovic-Djukic, and M. Grossglauser. CRAWDAD data set epfl/mobility (v. 2009-02-24). Downloaded from http://crawdad.org/epfl/mobility/, February 2009.
[23] M. Satyanarayanan, P. Bahl, R. Caceres, and N. Davies. The case for vm-based cloudlets in mobile computing. Pervasive Computing, IEEE, 8(4):14-23, 2009.
[24] C. Shi, V. Lakafosis, M. H. Ammar, and E. W. Zegura. Serendipity: enabling remote computing among intermittently connected mobile devices. In MobiHoc, pages 145-154, 2012.
[25] L. Spitzner. Honeypots: tracking hackers, volume 1. Addison-Wesley Reading, 2003.
[26] P. Traynor, M. Lin, M. Ongtang, V. Rao, T. Jaeger, P. McDaniel, and T. La Porta. On cellular botnets: measuring the impact of malicious devices on a cellular network core. In Proceedings of the 16th ACM conference on Computer and communications security, pages 223-234. ACM, 2009.
[27] I. Vural and H. Venter. Mobile botnet detection using network forensics. In Future Internet-FIS 2010, pages 57-67. Springer, 2010.
[28] S. Yi, P. Naldurg, and R. Kravets. Security-aware ad hoc routing for wireless networks. In Proceedings of the 2Nd ACM International Symposium on Mobile Ad Hoc Networking & Amp; Computing, MobiHoc '01, pages 299-302, New York, N.Y., USA, 2001. ACM.
[29] Y. Zeng, K. G. Shin, and X. Hu. Design of sms commanded-andcontrolled and p2p-structured mobile botnets. In Proceedings of the fifth ACM conference on Security and Privacy in Wireless and Mobile Networks, pages 137-148. ACM, 2012.
[30] Y. Zhang and W. Lee. Intrusion detection in wireless ad-hoc networks. In Proceedings of the 6th Annual International Conference on Mobile Computing and Networking, MobiCom '00, pages 275-283, New York, N.Y., USA, 2000. ACM.

1. A security method in a network environment comprising a corporate network populated with one or more devices connectable to the corporate network over a first communication interface and connectable to other devices over a device-to-device communication interface distinct from the first communication interface, each device comprising a node in the network, one or more of the devices comprising a mobile device and one or more of the devices comprising an intentionally vulnerable node in the network, the method comprising:
logging exchanged messages across the interfaces at the intentionally vulnerable node;
monitoring the interfaces;
identifying a candidate malicious message;
tracking back from messages, including from a candidate malicious message;
determining the paths used by the messages; and
determining the source and/or destination of a path to localise the candidate malicious message source.

2. The method of claim 1, wherein the intentionally vulnerable node logs all exchanged messages across all interfaces.

3. The method of claim 1, wherein the device-to-device communication interface is a Bluetooth™ or other short range wireless communication method.

4. The method of claim 1, wherein monitoring the interfaces comprises monitoring the interfaces for intrusions.

5. The method of claim 1, wherein the method utilises tracking heuristics and algorithms implemented at the one or more intentionally vulnerable nodes.

6. The method of claim 1, wherein a plurality of intentionally vulnerable nodes are provided.

7. The method of claim 6, wherein the plurality of intentionally vulnerable nodes are physically distributed around the network and tracking comprises physically locating a candidate malicious node in the network.

8. The method of claim 7, wherein the intentionally vulnerable nodes are physically distributed around the network according to a social-based placement and/or a static placement.

9. The method of claim 7, wherein physically locating the candidate malicious node in the network includes obtaining wireless RSSI measurements.

10. The method of claim 1, wherein the method further includes sending periodic fingerprint updates from the nodes.

11. The method of claim 7, wherein a candidate malicious node comprises a malicious mobile node and/or a victim node selected as a proxy that connects to a malicious mobile node external to the corporate network.

12. The method of claim 1, wherein the method comprises isolating a detected candidate malicious node from the corporate network.

13. The method of claim 1, wherein the method comprises disseminating code across nodes in the network which report interface activities to the intentionally vulnerable node.

14. The method of claim 1, wherein the method comprises using a detection phase substantially as hereinbefore described and/or illustrated.

15. The method of claim 1, wherein the method comprises using a tracking phase substantially as hereinbefore described and/or illustrated.

16. The method of claim 1, wherein the method comprises using an isolation phase substantially as hereinbefore described and/or illustrated.

17. A non-transitory computer-readable medium having computer-readable instructions such that, when executed, cause a processor to perform a security method in a network environment comprising a corporate network populated with one or more devices connectable to the corporate network over a first communication interface and connectable to other devices over a device-to-device communication interface distinct from the first communication interface, each device comprising a node in the network, one or more of the devices comprising a mobile device and one or more of the devices comprising an intentionally vulnerable node in the network, the method comprising:
logging exchanged messages across the interfaces at the intentionally vulnerable node;
monitoring the interfaces;
identifying a candidate malicious message;
tracking back from messages, including from a candidate malicious message;
determining the paths used by the messages; and
determining the source and/or destination of a path to localise the candidate malicious message source.

18. A mobile device having a non-transitory computer-readable medium having instructions such that a security method in a network environment comprising a corporate network populated with one or more devices connectable to the corporate network over a first communication interface and connectable to other devices over a device-to-device communication interface distinct from the first communication interface, each device comprising a node in the network, one or more of the devices comprising a mobile device and one or more of the devices comprising an intentionally vulnerable node in the network, the method comprising:
logging exchanged messages across the interfaces at the intentionally vulnerable node;
monitoring the interfaces;
identifying a candidate malicious message;
tracking back from messages, including from a candidate malicious message;
determining the paths used by the messages; and
determining the source and/or destination of a path to localise the candidate malicious message source.
